(19) United States
(12) Patent Application Publication
(10) Pub. No.: US 2011/0262803 A1
(43) Pub. Date: Oct. 27, 2011

(54) Electrodes and Electrochemical Cells Employing the Same

(75) Inventors: Biying Huang, Camarillo, CA (US); Ximei Sun, Suzhou (CN); Hongxia Zhou, Ann Arbor, MI (US); George Adamson, Camarillo, CA (US)

(73) Assignee: ZPower, Inc., Camarillo, CA (US)

(21) Appl. No.: 12/934,283

(22) PCT Filed: Mar. 27, 2009
(86) PCT No.: PCT/US09/01888

§ 371 Date: Jan. 12, 2011

Related U.S. Application Data
(60) Provisional application No. 61/039,963, filed on Mar. 27, 2008.

(51) Int. Cl. H01M 4/62; H01M 4/48; H01M 10/04; H01M 4/525; H01M 4/505; H01M 4/485; H01M 10/02; H01M 4/54

(52) U.S. Cl. 429/206; 429/188; 29/623.1; 252/182.1

(57) ABSTRACT

The present invention provides novel electrodes and electrochemical cells using these electrodes. Several embodiments presented by this invention provide novel cathodes that include an AgO active material and a PVDF binder. Furthermore, this invention also presents methods of manufacturing novel electrochemical cells and novel electrodes.

### CROSS-REFERENCE TO RELATED APPLICATION

This PCT patent application claims priority to U.S. Provisional Patent Application Ser. No. 61/039,963, which was filed on Mar. 27, 2008 and is hereby incorporated by reference.

### FIELD OF THE INVENTION

This invention is concerned with new electrodes and alkaline electrochemical cells that use these electrodes, such as batteries.

### BACKGROUND

Many traditional electrochemical cells, such as those found in batteries, use electrodes that are formed from an active material and a binder that are combined to create a paste or gel that is applied to a current collector, such as a mesh current collector. The current collector (e.g., a conductive mesh) aggregates charge from the active material.

In cells configured as described above, the binder has several functions: 1. to distribute the electrode active materials so that they are electrically connected with each other, 2. to bond the electrode active materials to their respective current collectors, and 3. to coat and protect the electrode active materials from direct contact with the electrolyte.

A binder suited for use in an electrochemical cell such as a battery should at least perform these three functions. Traditional binders such as PTFE and CMC present manufacturing problems or have physical properties that limit the efficiency of electrochemical cells, and thus, limiting the utility, cycle life, or shelf life of batteries.

For instance, PTFE possesses poor solubility in most solvents, so the ability to manufacture a uniform mixture of active material and PTFE is difficult, and typically requires the use of surfactants to make a PTFE suspension for uniform distribution of electrode active materials and binder material. However, surfactants promote undesired side effects on a battery performance. Other efforts to create a uniform mixture of active material and binder included creating water-based PTFE suspensions, which impairs subsequent electrode coating processes, and scale-ability for battery manufacturing. Another traditional binder is CMC, which has favorable gelling properties; however it is a very poor binding agent for strong oxidizing active materials such as metal oxides (e.g., AgO, Ag₂O₃, and/or Ag₂O). CMC also has a tendency to generate gas during battery cycling and storage that may be caused by the poor coating property of CMC on the active materials.

Therefore, the present invention provides improved electrodes that are free of one or more of the abovementioned problems suffered by traditional binders.

### SUMMARY OF THE INVENTION

The present invention provides novel electrodes comprising one or more electrode active materials and a binder material, wherein the binder material comprises PVDF or a copolymer thereof.

Another aspect of the present invention provides novel electrochemical cells, such as those used in batteries, that comprise an alkaline electrolyte, an anode, and a cathode, wherein the anode comprises a first binder material and a first active material, and the cathode comprises a second binder material and a second active material, and either the first binder material, the second binder material, or both comprises PVDF or a copolymer thereof.

A third aspect of the present invention provides a method of producing an electrode for use in an alkaline battery comprising providing a binder material and providing an electrode active material, wherein the binder material comprises PVDF or a copolymer thereof.

A fourth aspect of the present invention provides a method of producing an alkaline electrochemical cell comprising providing an alkaline electrolyte, providing an anode, and providing a cathode, wherein the anode comprises a first binder material and a first active material, and the cathode comprises a second binder material and a second active material, and either the first binder material, the second binder material, or both comprises PVDF or a copolymer thereof.

### BRIEF DESCRIPTION OF THE FIGURES

FIG. 1 is an illustration of an exemplary electrochemical cell configuration that was used to test the properties of electrodes and electrochemical cells;

FIG. 2A is a graphical representation of the charge profile, i.e., traces of 1. voltage vs. time, 2. current vs. time, and 3. capacity vs. time, each of which is superimposed on a single graph, of test cell no. 1 of the present invention including a novel cathode of the present invention over a duration of more than about 38 hours;

FIG. 2B is a graphical representation of the charge profile of test cell no. 1, profiled in FIG. 2A, over a duration of more than about 420 hours;

FIG. 3 is a graphical representation of the charge profile of test cell no. 2 over a duration of more than about 54 hours;

FIGS. 4A-4C are graphical representations of charge profiles of test cell nos. 3-5;

FIGS. 5A-5C are graphical representations of charge profiles of test cell nos. 6-8;

FIG. 6 is a graphical representation of a charge profile of test cell no. 9;

FIG. 7 is a graphical representation of a charge profile of test cell no. 10;

FIG. 8 is a trace of cell capacity as a function of charge cycles for test cell no. 10;

FIG. 9 is a graphical representation of a charge profile of test cell no. 11;

FIG. 10 is a trace of cell capacity as a function of charge cycles for test cell no. 11;

FIG. 11 is a graphical representation of a charge profile of test cell no. 12;

FIG. 12 is a trace of cell capacity as a function of charge cycles for test cell no. 12;

FIG. 13 is a graphical representation of a charge profile of test cell no. 13;

FIG. 14 is a trace of cell capacity as a function of charge cycles for test cell no. 13;

FIG. 15 is a graphical representation of a charge profile of test cell no. 14;

FIG. 16 is a graphical representation of a charge profile of test cell no. 14 after the cell was rebagged; and

FIGS. 17 and 18 are charge profiles of test cell no. 15.

### DETAILED DESCRIPTION

The present invention provides novel electrodes comprising an active material and a binder material. These electrodes are useful in electrochemical cells such as those used in alkaline batteries.

### I. DEFINITIONS

The term “battery” encompasses electrical storage devices comprising one electrochemical cell or a plurality of electrochemical cells. A “secondary battery” is rechargeable, whereas a “primary battery” is not rechargeable. For secondary batteries of the present invention, a battery anode is designated as the positive electrode during discharge, and as the negative electrode during charge.

The term “alkaline battery” refers to a primary battery or a secondary battery, wherein the primary or secondary battery comprises an alkaline electrolyte.

As used herein, an “electrolyte” refers to a substance that behaves as an electrically conductive medium. For example, the electrolyte facilitates the mobilization of electrons and cations in the cell. Electrolytes include mixtures of materials such as aqueous solutions of alkaline agents. Some electrolytes also comprise additives such as buffers. For example, an electrolyte comprises a buffer comprising a borate or a phosphate. Exemplary electrolytes include, without limitation aqueous KOH, aqueous NaOH, or the liquid mixture of KOH in a polymer.

As used herein, “alkaline agent” refers to a base or ionic salt of an alkali metal (e.g., an aqueous hydroxide of an alkali metal). Furthermore, an alkaline agent forms hydroxide ions when dissolved in water or other polar solvents. Exemplary alkaline electrolytes include without limitation LiOH, NaOH, KOH, CsOH, RbOH, or combinations thereof.

A “cycle” refers to a single charge and discharge of a battery.

For convenience, the polymer name “polyvinylidene fluoride” and its corresponding initials “PVDF” is used interchangeably as adjectives to distinguish polymers, solutions for preparing polymers, and polymer coatings. Use of these names and initials in no way implies the absence of other constituents. These adjectives also encompass substituted and co-polymerized polymers. A substituted polymer denotes one for which a substituent group, a methyl group, for example, replaces a hydrogen on the polymer backbone.

As used herein, “Ah” refers to Ampere (Amp) Hour and is a scientific unit for the capacity of a battery or electrochemical cell. A derivative unit, “mAh” represents a milliamp hour and is 1/1000 of an Ah.

As used herein, “maximum voltage” or “rated voltage” refers to the maximum voltage an electrochemical cell can be charged without interfering with the cell's intended utility. For example, in several zinc-silver electrochemical cells that are useful in portable electronic devices, the maximum voltage is less than about 3.0 V (e.g., less than about 2.8 V, less than about 2.5 V, about 2.3 V or less, or about 2.0 V). In other batteries, such as lithium ion batteries that are useful in portable electronic devices, the maximum voltage is less than about 15.0 V (e.g., less than about 13.0 V, or about 12.6 V or less). The maximum voltage for a battery can vary depending on the number of charge cycles constituting the battery's useful life, the shelf-life of the battery, the power demands of the battery, the configuration of the electrodes in the battery, and the amount of active materials used in the battery.

When referring to a polymer, the term “Mn” is used interchangeably with “mean molecular weight”.

As used herein, an “anode” is an electrode through which (positive) electric current flows into a polarized electrical device. In a battery or galvanic cell, the anode is the negative electrode from which electrons flow during the discharging phase in the battery. The anode is also the electrode that undergoes chemical oxidation during the discharging phase. However, in secondary, or rechargeable, cells, the anode is the electrode that undergoes chemical reduction during the cell's charging phase. Anodes are formed from electrically conductive or semiconductive materials, e.g., metals, metal oxides, metal alloys, metal composites, semiconductors, or the like. Common anode materials include Si, Sn, Al, Ti, Mg, Fe, Bi, Zn, Sb, Ni, Pb, Li, Zr, Hg, Cd, Cu, LiC₆, mischmetals, alloys thereof, oxides thereof, or composites thereof.

Anodes may have many configurations. For example, an anode may be configured from a conductive mesh or grid that is coated with one or more anode materials. In another example, an anode may be a solid sheet or bar of anode material.

As used herein, a “cathode” is an electrode from which (positive) electric current flows out of a polarized electrical device. In a battery or galvanic cell, the cathode is the positive electrode into which electrons flow during the discharging phase in the battery. The cathode is also the electrode that undergoes chemical reduction during the discharging phase. However, in secondary or rechargeable cells, the cathode is the electrode that undergoes chemical oxidation during the cell's charging phase. Cathodes are formed from electrically conductive or semiconductive materials, e.g., metals, metal oxides, metal alloys, metal composites, semiconductors, or the like. Common cathode materials include AgO, Ag₂O, Ag₂O₃, HgO, Hg₂O, CuO, CdO, NiOOH, Pb₂O₄, PbO₂, LiFePO₄, Li₃V₂(PO₄)₃, V₆O₁₃, V₂O₅, Fe₃O₄, Fe₂O₃, MnO₂, LiCoO₂, LiNiO₂, LiMn₂O₄, or composites thereof.

Cathodes may also have many configurations. For example, a cathode may be configured from a conductive mesh that is coated with one or more cathode materials. In another example, a cathode may be a solid sheet or bar of cathode material.

As used herein, an “electronic device” is any device that is powered by electricity. For example, and electronic device can include a portable computer, a portable music player, a cellular phone, a portable video player, or any device that combines the operational features thereof.

As used herein, “cycle life” is the maximum number of times a secondary battery can be charged and discharged.

The symbol “M” denotes molar concentration.

Batteries and battery electrodes are denoted with respect to the active materials in the fully-charged state. For example, a zinc-silver oxide battery comprises an anode comprising zinc and a cathode comprising silver oxide. Nonetheless, more than one species is present at a battery electrode under most conditions. For example, a zinc electrode generally comprises zinc metal and zinc oxide (except when fully charged), and a silver oxide electrode usually comprises a silver oxide (AgO, Ag₂O, and/or Ag₂O₃) and silver metal (except when fully discharged).

The term “oxide” applied to alkaline batteries and alkaline battery electrodes encompasses corresponding “hydroxide” species, which are typically present, at least under some conditions.

As used herein “substantially stable” refers to a compound or component that remains substantially chemically unchanged in the presence of an alkaline electrolyte (e.g., potassium hydroxide) and/or in the presence of an oxidizing agent (e.g., silver ions present in the cathode or dissolved in the electrolyte).

As used herein, the terms “first” and/or “second” do not refer to order or denote relative positions in space or time, but these terms are used to distinguish between two different elements or components. For example, a first separator does not necessarily proceed a second separator in time or space; however, the first separator is not the second separator and vice versa. Although it is possible for a first separator to proceed a second separator in space or time, it is equally possible that a second separator proceeds a first separator in space or time.

### II. ELECTRODES

One aspect of the present invention provides electrodes for use in electrochemical cells having a strong alkaline environment such as those found in alkaline batteries. Such electrodes comprise a binder material and an active material, wherein the binder material comprises PVDF or a PVDF copolymer.

Electrodes of the present invention can comprise any suitable active material such as a metal oxide (e.g., AgO, Ag₂O, Ag₂O₃, or the like), and metal alloys such as Ni—Zn alloys.

In one embodiment the electrode active material comprises at least one metal or metal oxide. In several embodiments, the electrode is a cathode and the active material is one selected from AgO, Ag₂O₃, Ag₂O, HgO, Hg₂O, CuO, CdO, NiOOH, Pb₂O₄, PbO₂, LiFePO₄, Li₃V₂(PO₄)₃, V₆O₁₃, V₂O₅, Fe₃O₄, Fe₂O₃, MnO₂, LiCoO₂, LiNiO₂, LiMn₂O₄, or composites thereof. For example, the electrode is a cathode having an active material comprising AgO or Ag₂O₃. In another embodiment, the electrode is an anode and the active material is one selected from Si, Sn, Al, Ti, Mg, Fe, Bi, Zn, Sb, Ni, Pb, Li, Zr, Hg, Cd, Cu, LiC₆, mischmetals, alloys thereof, oxides thereof, or composites thereof. Anodes of the present invention can also comprise inactive compounds such as ceramics (e.g., ITO, TiN or TiNOₓ). For example, the electrode is an anode having an active material comprising Zn or ZnO.

Electrodes of the present invention comprise at least about 70 wt % of active material. For instance an electrode comprises at least 75 wt % (e.g., at least 80 wt %, at least 90 wt %, or at least 95 wt %) of active material. For example, a cathode comprises up to at least 90 wt % of the active material (e.g., AgO or Ag₂O₃).

Electrodes of the present invention also comprise binder material that includes PVDF or a PVDF copolymer. For example, the electrode comprises a PVDF copolymer consisting essentially of PVDF-co-HFP. Electrodes can comprise from about 1.5 wt % to about 10 wt % (e.g., from about 1.5 wt % to about 7 wt %) of binder material. Any of the abovementioned anodes or cathodes can comprise this binder material in the amounts described. In several embodiments, binder materials are substantially free of surfactants, i.e., having less than 0.5 wt % (e.g., less than 0.3 wt % or less than 0.25 wt %) of surfactant.

Electrodes of the present invention can comprise optional additives such as Bi₂O₃ in an amount of up to about 3 wt %.

Electrodes such as cathodes can comprise active materials that are coated or doped with other additives. One example provides a cathode comprising AgO that is doped with from about 0.5 wt % to about 10 wt % Pb. In another example, the cathode comprises AgO that is doped with from about 0.5 wt % to about 10 wt % Pb and coated with from about 0.5 wt % to about 5 wt % Pb.

### III. ELECTROCHEMICAL CELLS

A. Electrodes

Another aspect of the present invention provides electrochemical cells comprising an alkaline electrolyte, a cathode, and an anode; wherein the cathode comprises a first active material and a first binder material; the anode comprises a second active material and a second binder material; and the first binder material, the second binder material, or both comprises PVDF or PVDF copolymer.

In several embodiments, the cathode comprises at least 90 wt % of the first active material. For example, the cathode comprises at least 90 wt % of an active material selected from AgO, Ag₂O, Ag₂O₃, HgO, Hg₂O, CuO, CdO, NiOOH, Pb₂O₄, PbO₂, LiFePO₄, Li₃V₂(PO₄)₃, V₆O₁₃, V₂O₅, Fe₃O₄, Fe₂O₃, MnO₂, LiCoO₂, LiNiO₂, LiMn₂O₄, or composites thereof.

In several examples, the active material of the cathode comprises AgO or Ag₂O₃.

In several embodiments, a cathode comprises up to about 10 wt % (e.g., up to about 6 wt %) of a binder material. For instance, the cathode comprises up to about 10 wt % of a binder that comprises PVDF or PVDF copolymer. In other examples, the binder material comprises a PVDF copolymer such as PVDF-co-HFP copolymer. In several embodiments, the PVDF-co-HFP copolymer has a mean molecular weight of less than about 600,000 amu (e.g., less than about 500,000 amu, or about 400,000 amu).

In alternative embodiments, an anode useful in the present electrochemical cells comprises at least 90 wt % of the second active material. For instance, an anode comprises at least about 90 wt % of an active material selected from Si, Sn, Al, Ti, Mg, Fe, Bi, Zn, Sb, Ni, Pb, Li, Zr, Hg, Cd, Cu, LiC₆, mischmetals, alloys thereof, oxides thereof, or composites thereof. In several examples, the anode comprises an active material comprising Zn or ZnO.

In several embodiments, the anode comprises up to 10 wt % of a binder material. For instance, the anode comprises up to 6 wt % of a binder material. In several examples, the anode comprises binder material comprises up to 10 wt % of a binder material comprising PVDF or PVDF copolymer. For instance, the binder material comprises a PVDF copolymer such as PVDF-co-HFP copolymer. In other examples, the PVDF-co-HFP copolymer has a mean molecular weight of less than about 600,000 amu (e.g., less than about 500,000 amu, or about 400,000 amu).

B. Separator

Electrochemical cells of the present invention additionally comprise a separator that is separates the anode from the cathode.

Separators of the present invention can comprise a film having a single layer or a plurality of layers, wherein the plurality of layers may comprise a single polymer (or copolymer) or more than one polymer (or copolymer).

In several embodiments, the separators comprise a unitary structure formed from at least two strata. The separator can include strata wherein each layer comprises the same material, or each layer comprises a different layer, or the strata are layered to provide layers of the same material and at least on layer of another material. In several embodiments, one stratum comprises an oxidation resistant material, and the remaining stratum comprises a dendrite resistant material. In other embodiments, at least one stratum comprises an oxidation-resistant material, or at least one stratum comprises a dendrite-resistant material. The unitary structure is formed when the material comprising one stratum (e.g., an oxidation-resistant material) is coextruded with the material comprising another stratum (e.g., a dendrite resistant material or oxidation-resistant material). In several embodiments, the unitary separator is formed from the coextrusion of oxidation-resistant material with dendrite-resistant material.

In several embodiments, the oxidation-resistant material comprises a polyether polymer mixture and the dendrite resistant material comprises a PVA polymer mixture.

It is noted that separators useful in electrochemical cells can be configured in any suitable way such that the separator is substantially inert in the presence of the anode, cathode and electrolyte of the electrochemical cell. For example, a separator for a rectangular battery electrode may be in the form of a sheet or film comparable in size or slightly larger than the electrode, and may simply be placed on the electrode or may be sealed around the edges. The edges of the separator may be sealed to the electrode, an electrode current collector, a battery case, or another separator sheet or film on the backside of the electrode via an adhesive sealant, a gasket, or fusion (heat sealing) of the separator or another material. The separator may also be in the form of a sheet or film wrapped and folded around the electrode to form a single layer (front and back), an overlapping layer, or multiple layers. For a cylindrical battery, the separator may be spirally wound with the electrodes in a jelly-roll configuration. Typically, the separator is included in an electrode stack comprising a plurality of separators. The oxidation-resistant separator of the invention may be incorporated in a battery in any suitable configuration.

1. Polyether Polymer Material

In several embodiments of the present invention the oxidation-resistant stratum of the separator comprises a polyether polymer material that is coextruded with a dendrite-resistant material. The polyether material can comprise polyethylene oxide (PEO) or polypropylene oxide (PPO), or a copolymer or a mixture thereof. The polyether material may also be copolymerized or mixed with one or more other polymer materials, polyethylene, polypropylene and/or polytetrafluoroethylene (PTFE), for example. In some embodiments, the PE material is capable of forming a free-standing polyether film when extruded alone, or can form a free standing film when coextruded with a dendrite-resistant material. Furthermore, the polyether material is substantially inert in the alkaline battery electrolyte and in the presence of silver ions.

In alternative embodiments, the oxidation resistant material comprises a PE mixture that optionally includes zirconium oxide powder. Without intending to be limited by theory, it is theorized that the zirconium oxide powder inhibits silver ion transport by forming a surface complex with silver ions. The term “zirconium oxide” encompasses any oxide of zirconium, including zirconium dioxide and yttria-stabilized zirconium oxide. The zirconium oxide powder is dispersed throughout the PE material so as to provide a substantially uniform silver complexation and a uniform barrier to transport of silver ions. In several embodiments, the average particle size of the zirconium oxide powder is in the range from about 1 nm to about 5000 nm, e.g., from about 5 nm to about 100 nm.

In other embodiments, the oxidation-resistant material further comprises an optional conductivity enhancer. The conductivity enhancer can comprise an inorganic compound, potassium titanate, for example, or an organic material. Titanates of other alkali metals than potassium may be used. Suitable organic conductivity enhancing materials include organic sulfonates and carboxylates. Such organic compounds of sulfonic and carboxylic acids, which may be used singly or in combination, comprise a wide range of polymer materials that may include salts formed with a wide variety of electropositive cations, K⁺, Na⁺, Li⁺, Pb⁺², Ag⁺, NH4⁺, Ba⁺², Sr⁺², Mg⁺², Ca⁺² or anilinium, for example. These compounds also include commercial perfluorinated sulfonic acid polymer materials, Nafion® and Flemion®, for example. The conductivity enhancer may include a sulfonate or carboxylate copolymer, with polyvinyl alcohol, for example, or a polymer having a 2-acrylamido-2-methyl propanyl as a functional group. A combination of one or more conductivity enhancing materials can be used.

Oxidation-resistant material that is coextruded to form a separator of the present invention can comprise from about 5 wt % to about 95 wt % (e.g., from about 20 wt % to about 60 wt %, or from about 30 wt % to about 50 wt %) of zirconium oxide and/or conductivity enhancer.

Oxidation-resistant materials can also comprise additives such as surfactants that improve dispersion of the zirconium oxide powder by preventing agglomeration of small particles. Any suitable surfactant may be used, including one or more anionic, cationic, non-ionic, ampholytic, amphoteric and zwitterionic surfactants, and mixtures thereof. In one embodiment, the separator comprises an anionic surfactant. For example, the separator comprises an anionic surfactant, and the anionic surfactant comprises a salt of sulfate, a salt of sulfonate, a salt of carboxylate, or a salt of sarcosinate. One useful surfactant comprises p-(1,1,3,3-tetramethylbutyl)-phenyl ether, which is commercially available under the trade name Triton X-100 from Rohm and Haas.

In several embodiments, the oxidation-resistant material comprises from about 0.01 wt % to about 1 wt % of surfactant.

2. Polyvinyl Polymer Material

In several embodiments of the present invention the dendrite-resistant stratum of the separator comprises a polyvinyl polymer material that is coextruded with the oxidation-resistant material. In several embodiments, the PVA material comprises a cross-linked polyvinyl alcohol polymer and a cross-linking agent.

In several embodiments, the cross-linked polyvinyl alcohol polymer is a copolymer. For example, the cross-linked PVA polymer is a copolymer comprising a first monomer, PVA, and a second monomer. In some instances, the PVA polymer is a copolymer comprising at least 60 mole percent of PVA and a second monomer. In other examples, the second monomer comprises vinyl acetate, ethylene, vinyl butyral, or any combination thereof.

PVA material useful in separators of the present invention also comprise a cross-linking agent in a sufficient quantity as to render the separator substantially insoluble in water. In several embodiments, the cross-linking agent used in the separators of the present invention comprises a monoaldehyde (e.g., formaldehyde or glyoxilic acid); aliphatic, furyl or aryl dialdehydes (e.g., glutaraldehyde, 2,6 furyldialdehyde or terephthaldehyde); dicarboxylic acids (e.g., oxalic acid or succinic acid); polyisocyanates; methylolmelamine; copolymers of styrene and maleic anhydride; germaic acid and its salts; boron compounds (e.g., boron oxide, boric acid or its salts; or metaboric acid or its salts); or salts of copper, zinc, aluminum or titanium. For example, the cross-linking agent comprises boric acid.

In another embodiment, the PVA material optionally comprises zirconium oxide powder. In several embodiments, the PVA material comprises from about 1 wt % to about 99 wt % (e.g., from about 2 wt % to about 98 wt %, from about 20 wt % to about 60 wt %, or from about 30 wt % to about 50 wt %).

In many embodiments, the dendrite-resistant strata of the separator of the present invention comprises a reduced ionic conductivity. For example, in several embodiments, the separator comprises an ionic resistance of less than about 20 mΩ/cm², (e.g., less than about 10 mΩ/cm², less than about 5 mΩ/cm², or less than about 4 mΩ/cm²).

The PVA material that forms the dendrite-resistant stratum of the separator of the present invention can optionally comprise any suitable additives such as a conductivity enhancer, a surfactant, a plasticizer, or the like.

In some embodiments, the PVA material further comprises a conductivity enhancer. For example, the PVA material comprises a cross-linked polyvinyl alcohol polymer, a zirconium oxide powder, and a conductivity enhancer. The conductivity enhancer comprises a copolymer of polyvinyl alcohol and a hydroxyl-conducting polymer. Suitable hydroxyl-conducting polymers have functional groups that facilitate migration of hydroxyl ions. In some examples, the hydroxyl-conducting polymer comprises polyacrylate, polylactone, polysulfonate, polycarboxylate, polysulfate, polysarconate, polyamide, polyamidosulfonate, or any combination thereof. A solution containing a copolymer of a polyvinyl alcohol and a polylactone is sold commercially under the trade name Vytek® polymer by Celanese, Inc. In several examples, the separator comprises from about 1 wt % to about 10 wt % of conductivity enhancer.

In other embodiments, the PVA material further comprises a surfactant. For example, the separator comprises a cross-linked polyvinyl alcohol polymer, a zirconium oxide powder, and a surfactant. The surfactant comprises one or more surfactants selected from an anionic surfactant, a cationic surfactant, a nonionic surfactant, an ampholytic surfactant, an amphoteric surfactant, and a zwitterionic surfactant. Such surfactants are commercially available. In several examples, the PVA material comprises from about 0.01 wt % to about 1 wt % of surfactant.

In several embodiments, the dendrite-resistant stratum further comprises a plasticizer. For example, the dendrite-resistant stratum comprises a cross-linked polyvinyl alcohol polymer, a zirconium oxide powder, and a plasticizer. The plasticizer comprises one or more plasticizers selected from glycerin, low-molecular-weight polyethylene glycols, aminoalcohols, polypropylene glycols, 1,3 pentanediol branched analogs, 1,3 pentanediol, and/or water. For example, the plasticizer comprises greater than about 1 wt % of glycerin, low-molecular-weight polyethylene glycols, aminoalcohols, polypropylene glycols, 1,3 pentanediol branched analogs, 1,3 pentanediol, or any combination thereof, and less than 99 wt % of water. In other examples, the plasticizer comprises from about 1 wt % to about 10 wt % of glycerin, low-molecular-weight polyethylene glycols, aminoalcohols, polypropylene glycols, 1,3 pentanediol branched analogs, 1,3 pentanediol, or any combination thereof, and from about 99 wt % to about 90 wt % of water.

In some embodiments, the separator of the present invention further comprises a plasticizer. In other examples, the plasticizer comprises glycerin, a low-molecular-weight polyethylene glycol, an aminoalcohol, a polypropylene glycols, a 1,3 pentanediol branched analog, 1,3 pentanediol, or combinations thereof, and/or water.

3. Optional Substrate

In alternative embodiments, the separator of the present battery further comprises a substrate on which polymer materials (e.g., oxidation-resistant material and/or dendrite-reistant material) are coextruded. In some examples, the separate polymer materials are coextruded onto a single surface of the substrate. In other examples, the polymer materials are coextruded onto opposing surfaces of the substrate such that at least two strata forming the separator are separated by the substrate.

Substrates useful in these novel separators can comprise any suitable material that is substantially inert in an alkaline electrochemical cell. In several embodiments, the substrate is a woven or non-woven sheet. In other embodiments, the substrate is a non-woven sheet. Exemplary substrates that are commercially available include Solupor and Scimat, which are available from DSM Solutech Co. and SciMat, Ltd., respectively.

Electrochemical cells of the present invention can optionally comprise a separator layer comprising a PEO layer and a PVA layer. One such separator can be formed from solutions having substantially equivalent compositions used to prepare a bi-functional separator having individual separator layers. Polyvinyl alcohol layers were deposited from a 10 wt % PVA solution. The PEO solution comprised 87 to 97 wt % water, 2 to 6 wt % polyethylene oxide, 2 to 6 wt % yttria-stabilized zirconium oxide (filler), 0.2 to 1.5 wt % potassium titanate (conductivity enhancer), and 0.08 to 0.2 wt % Triton X-100 (surfactant). Conventional dispersing techniques were used to provide a uniform dispersion of the filler. The bi-functional separator was prepared by co-extrusion of the PVA and PEO solutions from a two-layer slot-die unit, and drying at 280° C. The individual separator layers were prepared using conventional film casting techniques.

In other embodiments, a separator is formed by coating a Solupor film with two layers of PEO material, wherein each layer of PEO material coats an opposing side of the Solupor film.

In another embodiment, the separator comprises a unitary structure comprising two layers of a PEO material that were coextruded to form a free standing separator.

C. Electrolytes

Electrochemical cells of the present invention comprise an alkaline electrolyte. In several embodiments, the electrolyte comprises NaOH or KOH. For instance, the electrolyte can comprise aqueous NaOH or KOH, or NaOH or KOH mixtures with liquids substantially free of water, such as liquid polymers. Exemplary alkaline polymer electrolytes include, without limitation, 90 wt % PEG-200 and 10 wt % KOH, 50 wt % PEG-200 and 50 wt % KOH; PEG-dimethyl ether that is saturated with KOH; PEG-dimethyl ether and 33 wt % KOH; PEG-dimethyl ether and 11 wt % KOH; and PEG-dimethyl ether (mean molecular weight of 500 amu) and 33 wt % KOH, that is further diluted to 11 wt % KOH with PEG-dimethyl ether having a mean molecular weight of 200 amu.

Exemplary electrolytes include aqueous metal-hydroxides such as NaOH and/or KOH. Other exemplary electrolytes include mixtures of a metal hydroxide and a polymer that is liquid at a range of operating and/or storage temperatures for the electrochemical cell into which it employed.

In other embodiments, the electrolyte is an aqueous mixture of NaOH or KOH having a concentration of at least 4 M (e.g., at least 8 M).

Polymers useful for formulating an electrolyte of the present invention are also at least substantially miscible with an alkaline agent. In one embodiment, the polymer is at least substantially miscible with the alkaline agent over a range of temperatures that at least includes the operating and storage temperatures of the electrochemical device in which the mixture is used. For example, the polymer is at least substantially miscible, e.g., substantially miscible with the alkaline agent at a temperature of at least −40° C. In other examples, the polymer is liquid at a temperature of at least −30° C. (e.g., at least −20° C., at least −10° C., or from about −40° C. to about 70° C.). In another embodiment, the polymer is at least substantially miscible with the alkaline agent at a temperature from about −20° C. to about 60° C. For example, the polymer is at least substantially miscible with the alkaline agent at a temperature of from about −10° C. to about 60° C.

In several embodiments, the polymer can combine with the alkaline agent at a temperature in the range of temperatures of the operation of the electrochemical device in which is it stored to form a solution.

In one embodiment, the electrolyte comprises a polymer of formula (I):

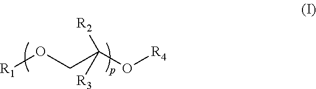

wherein each of R₁, R₂, R₃, and R₄ is independently (V₁-Q₁-V₂-Q₂-V₃-Q₃)ₙ, each of V₁, V₂, and V₃, is independently a bond or —O—, each of Q₁, Q₂, and Q₃, is independently a bond, hydrogen, or a C₁₋₄ linear unsubstituted alkyl, n is 1-5, and p is a positive integer of sufficient value such that the polymer of formula (I) has a total molecular weight of less than 10,000 amu (e.g., less than about 5000 amu, less than about 3000 amu, from about 50 amu to about 2000 amu, or from about 100 amu to about 1000 amu) and an alkaline agent.

In several embodiments, the polymer is straight or branched. For example, the polymer is straight. In other embodiments, R₁ is independently (V₁-Q₁-V₂-Q₂-V₃-Q₃)ₙ, wherein n is 1, each of V₁, Q₁, V₂, Q₂, and V₃ is a bond, and Q₃ is hydrogen. In some embodiments, R₄ is independently (V₁-Q₁-V₂-Q₂-V₃-Q₃)ₙ, wherein n is 1, each of V₁, Q₁, V₂, Q₂, and V₃, is a bond, and Q₃ is hydrogen. In other embodiments, both of R₁ and R₄ are (V₁-Q₁-V₂-Q₂-V₃-Q₃)ₙ, each n is 1, each of V₁, Q₁, V₂, Q₂, and V₃ is a bond, and each Q₃ is hydrogen.

However, in other embodiments, R₁ is independently (V₁-Q₁-V₂-Q₂-V₃-Q₃)ₙ, wherein n is 1, each of V₁, Q₁, V₂, Q₂, and V₃ is a bond, and Q₃ is —CH₃, —CH₂CH₃, —CH₂CH₂CH₃, or H. For example, R₁ is independently (V₁-Q₁-V₂-Q₂-V₃-Q₃)ₙ, wherein n is 1, each of V₁, Q₁, V₂, Q₂, and V₃ is a bond, and Q₃ is —CH₃ or H.

In another example, R₁ is independently (V₁-Q₁-V₂-Q₂-V₃-Q₃)ₙ, wherein n is 1, one of Q₁ or Q₂ is —CH₂—, —CH₂CH₂—, or —CH₂CH₂CH₂—; V₁ and V₂ are each a bond; V₃ is —O—, and Q₃ is H.

In several other examples R₄ is independently (V₁-Q₁-V₂-Q₂-V₃-Q₃)ₙ, wherein n is 1, each of V₁, Q₁, V₂, Q₂, is a bond, and V₃ is —O— or a bond, and Q₃ is hydrogen, —CH₃, —CH₂CH₃, or —CH₂CH₂CH₃. For example, R₄ is independently (V₁-Q₁-V₂-Q₂-V₃-Q₃)ₙ, wherein n is 1, each of V₁, Q₁, V₂, Q₂, and V₃ is a bond, and Q₃ is —CH₃, —CH₂CH₃, or —CH₂CH₂CH₃.

In another embodiment, R₁ is (V₁-Q₁-V₂-Q₂-V₃-Q₃)ₙ, wherein n is 1, each of V₁, Q₁, V₂, Q₂, and V₃ is a bond, and Q₃ is —CH₃, and R₄ is (V₁-Q₁-V₂-Q₂-V₃-Q₃)ₙ, wherein n is 1, each of V₁, Q₁, V₂, Q₂, is a bond, and V₃ is —O—, and Q₃ is —H.

In some embodiments, R₂ is independently (V₁-Q₁-V₂-Q₂-V₃-Q₃)ₙ wherein n is 1, each of V₁, Q₁, V₂, Q₂, and V₃ is a bond, and Q is —CH₃, —CH₂CH₃, —CH₂CH₂CH₃, or H. In other embodiments, R₂ is independently (V₁-Q₁-V₂-Q₂-V₃-Q₃)ₙ, wherein n is 1, one of V₁, Q₁, V₂, Q₂, and V₃ is —O—, and Q₃ is —H.

In some embodiments, R₃ is independently (V₁-Q₁-V₂-Q₂-V₃-Q₃)ₙ, wherein n is 1, each of V₁, Q₁, V₂, Q₂, and V₃ is a bond, and Q₃ is —CH₃, —CH₂CH₃, —CH₂CH₂CH₃, or H. In other embodiments, R₃ is independently (V₁-Q₁-V₂-Q₂-V₃-Q₃)ₙ, wherein n is 1, one of V₁, Q₁, V₂, Q₂, and V₃ is —O—, and Q₃ is —H.

In some embodiments, one of R₁ or R₄ is an alkyl group and the other is hydrogen. In other examples one of R₁ and R₄ is attached to the backbone of another polymer and the other is hydrogen.

In some embodiments, the polymer comprises a polyethylene oxide. In other examples, the polymer comprises a polyethylene oxide selected from polyethylene glycol, polypropylene glycol, polybutylene glycol, alkyl-polyethylene glycol, alkyl-polypropylene glycol, alkyl-polybutylene glycol, and any combination thereof.

In another embodiment, the polymer is a polyethylene oxide having a mean molecular weight of less than 10,000 amu (e.g., less than 5000 amu, or from about 100 amu to about 1000 amu). In other embodiments, the polymer comprises polyethylene glycol.

Alkaline agents useful in the electrolyte of the present invention are capable of producing hydroxyl ions when mixed with an aqueous or polar solvent such as water and/or a liquid polymer.

In some embodiments, the alkaline agent comprises LiOH, NaOH, KOH, CsOH, RbOH, or combinations thereof. For example, the alkaline agent comprises LiOH, NaOH, KOH, or combinations thereof. In another example, the alkaline agent comprises KOH.

In several exemplary embodiments, the electrolyte of the present invention comprises a liquid polymer of formula (I) and an alkaline agent comprising LiOH, NaOH, KOH, CsOH, RbOH, or combinations thereof. In other exemplary embodiments, the electrolyte comprises a liquid polymer comprising a polyethylene oxide; and an alkaline agent comprising LiOH, NaOH, KOH, CsOH, RbOH, or combinations thereof. For example, the electrolyte comprises a polymer comprising a polyethylene oxide and an alkaline agent comprising KOH.

In several exemplary embodiments, the electrolyte of the present invention comprises more than about 1 wt % of alkaline agent (e.g., more than about 5 wt % of alkaline agent, or from about 5 wt % to about 76 wt % of alkaline agent). In one example, the electrolyte comprises a liquid polymer comprising a polyethylene oxide and 3 wt % or more (e.g., 4 wt % or more, from about 4 wt % to about 33 wt %, or from about 5 wt % to about 15 wt %) of an alkaline agent. For instance, the electrolyte comprises polyethylene oxide and 5 wt % or more of KOH. In another example, the electrolyte consists essentially of a polyethylene oxide having a molecular weight or mean molecular weight from about 100 amu to about 1000 amu and 5 wt % or more of KOH.

Electrolytes of the present invention can be substantially free of water. In several embodiments, the electrolyte comprises water in an amount of about 60 wt % or less (e.g., about 50 wt % or less, about 40 wt % or less, about 30 wt % or less, about 25 wt % or less, about 20 wt % or less, or about 10 wt % or less).

Exemplary alkaline polymer electrolytes include, without limitation, 90 wt % PEG-200 and 10 wt % KOH, 50 wt % PEG-200 and 50 wt % KOH; PEG-dimethyl ether that is saturated with KOH; PEG-dimethyl ether and 33 wt % KOH; PEG-dimethyl ether and 11 wt % KOH; and PEG-dimethyl ether (mean molecular weight of 500 amu) and 33 wt % KOH, that is further diluted to 11 wt % KOH with PEG-dimethyl ether having a mean molecular weight of 200 amu.

### IV. METHODS

Another aspect of the present invention provides methods of manufacturing electrochemical cells comprising providing a cathode comprising AgO and a first binder material; providing an anode comprising Zn or ZnO and a second binder material; and providing an alkaline electrolyte, wherein the alkaline electrolyte comprises NaOH or KOH in a concentration of at least 8 M, the cathode comprises at least about 88 wt % of AgO, the anode comprises at least 88 wt % of Zn or ZnO, and either the first binder material, the second binder material, or both comprises PVDF or a PVDF copolymer.

In several examples, the active material of the cathode comprises AgO. In other examples, the AgO is doped with up to 10 wt % of Pb. In several examples, the AgO is doped with up to 5 wt % of Pb, or the AgO is doped with up to 5 wt % of Pb and is coated with up to 5 wt % Pb.

In several embodiments, the anode comprises up to 10 wt % of a binder material. For instance, the anode comprises up to 6 wt % of a binder material. In several examples, the anode comprises binder material comprises up to 10 wt % of a binder material comprising PVDF or PVDF copolymer. For instance, the binder material comprises a PVDF copolymer such as PVDF-co-HFP copolymer. In other examples, the PVDF-co-HFP copolymer has a mean molecular weight of less than about 600,000 amu (e.g., less than about 500,000 amu, or about 400,000 amu).

### V. EXAMPLES

In the examples below, several exemplary electrodes (anodes and/or cathodes) of the present invention are described. Several of these exemplary electrodes are evaluated by incorporating them into test electrochemical cells of the present invention, which are described and evaluated below. It is noted that these test cells are intended to be non-limiting examples of electrochemical cells of the present invention.

### Example 1

### Fabrication of Exemplary Anodes with PVDF-co-HFP Binder

Materials:
Zn powder (GN-10, Grillo-werke, Germany)
ZnO powder (Sigma-Aldrich, USA)
Bi₂O₃ powder (99.975% [metal basis], Alfa Aesar, USA)
Poly (vinylidene fluoride-co-hexafluoropropylene) (PVDF-co-HFP) pellet (Mn=130,000, Mw=400,000, Sigma-Aldrich, USA)
Acetone (99.5+% ACS reagent, Sigma-Aldrich, USA)

Processing Procedure:

1. Preparing the PVDF-co-HFP solution: dissolve the PVDF-co-HFP into the acetone (weight ratio—PVDF-co-HFP:acetone=1:7 to 1:11);

2. Dry powder mixing: break the ZnO agglomerates manually if any, mix Bi₂O₃, ZnO and Zn (GN-10) with the desired amount in Flectek at 1000 rpm for 1 to 2 minutes;

3. Add the solution from step 1 with the desired binder content into the mixture of dry powders from step 2 and mix them in the Flecteck (or other suitable mixer) at 1000 rpm for 2 minutes;

4. Manually mix the slurry from step 3 with a stainless spoon and when seeing a uniform slurry, quickly pour it into the clean glass plate and air dry the slurry;

5. Peel off the dried film and use a cookie cutter to obtain the desired dimension of the zinc anode;

6. Weigh the anode half to the desired amount; and

7. Load the anode half into the mold fixture, put in the anode collector, load the other half of anode on the top of the collector, close the mold and press at 5 ton for 30 seconds.

This procedure was generally followed to produce anodes having formulations according to Table 1, below:

TABLE 1
Formulations for 3 exemplary anodes.

| | 5% PVDF- | 3% PVDF- | 2% PVDF- |
|---|---|---|---|
| Materials | co-HFP | co-HFP | co-HFP |
| Zn (g) | 87.77 | 89.63 | 90.56 |
| ZnO (g) | 6.76 | 6.90 | 6.97 |
| Bi₂O₃ (g) | 0.47 | 0.47 | 0.47 |
| PVDF-co-HFP (g) | 5.00 | 3.00 | 2.00 |

Each of the amounts presented in Table 1 are in units of wt %.

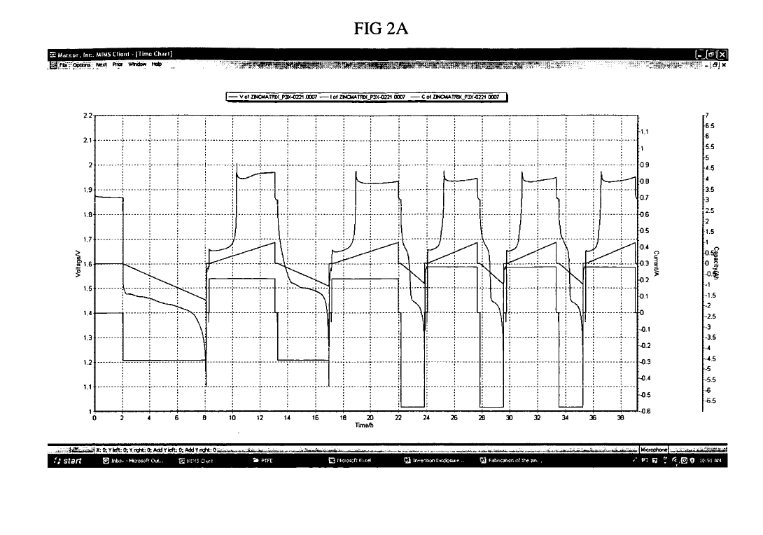

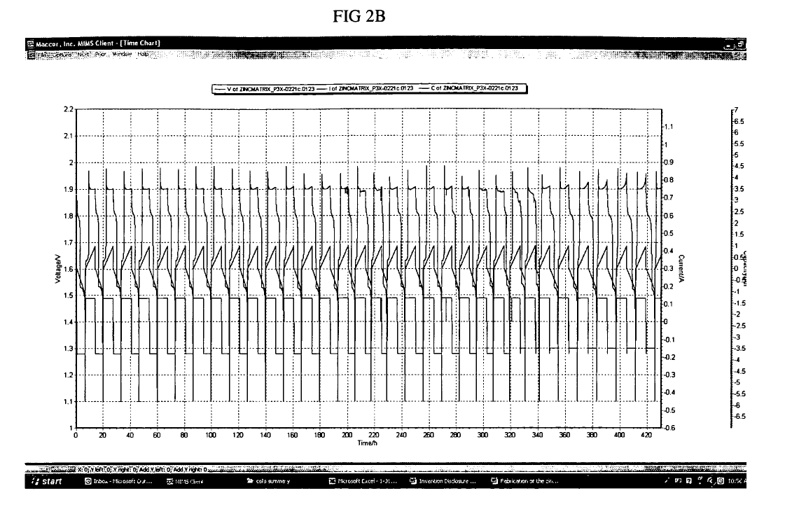

The charging profile as well as capacity evaluations for the abovementioned anodes are provided in FIGS. 2A-18.

### Example 2

### Exemplary Cathodes with PVDF-co-HFP Binder

Materials:
PbAc coated AgO powder (PbAc: AgO=1.5:100, D.F. Goldsmith Chemical and Metal Corp.)
PVDF-co-HFP pellet (Mn=130,000, Mw=400,000, Sigma-Aldrich, USA)
Propylene carbonate (PC) (99% reagent plus, Sigma-Aldrich, USA)

Test Cathode Active Material

The test cathode active material used in test cells described below was PbAc coated

AgO powder (PbAc: AgO=1.5:100, D.F. Goldsmith Chemical and Metal Corp.).

### Example 3

### Test Cell 1 for the Evaluation of PVDF Binder

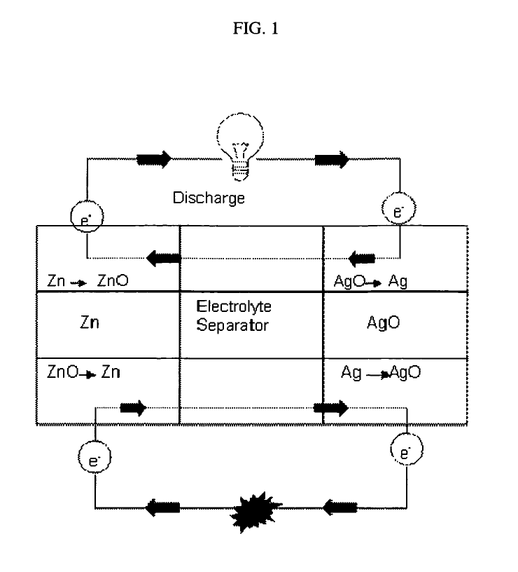

FIGS. 1, 2A, and 2B illustrate a cell configuration and charge profile for test cell 1. FIGS. 2A and 2B show traces for: 1. cell voltage vs. time; 2. cell capacity vs. time; and 3. charge current vs. time, wherein each of the traces is superimposed on the same graph.

This cell was produced using the following components:

Cathode: Test Cathode Active Material with 1 wt % PTFE binder

Anode: Zn with 5 wt % PVDF binder

Electrolyte: (40 wt % conc.) aq. KOH

The electrodes were separately wrapped in a PEO film. The PEO film was formulated as follows:

| | | |
|---|---|---|
| Polyethylene oxide (Alkox) | 3.7 | w % |
| Deionized Water | 70.6 | w % |
| Potassium Titanate (Mintchem Group) | 0.9 | w % |
| Colloidal Zirconium Oxide (Alfa Aesar) | 24.8 | w % |
| Triton X-100 (Aldrich) | 3 | drops |

Each of these ingredients were mixed and a sufficient amount of the resulting mixture was cast onto a 25 micron porous polyolefin substrate (i.e. Solupor, DSM Solutech) to give a PEO film having a dry thickness of about 40 microns.

A separator was situated between the electrodes. The separator included a free standing structure including two PVA-based layers that were each formulated from:

| | | |
|---|---|---|
| Yittria Stabilized Zirconium Oxide (Hicharms) | 4.4 | w % |
| Polyvinyl Alcohol (Dupont Elvanol) | 7.4 | w % |
| Boric Acid (Aldrich) | 0.2 | w % |
| Deionized Water | 88 | w % |

These ingredients were mixed and cast in a glass tray so that the final dry thickness is approximately 40 microns.

The separator was soaked in the KOH solution for 12 hours before being assembled into the cell. Charge current was C/10 for the first 2 charge cycles and reached 2.03 V. After the first 2 charge cycles, a constant voltage of 1.98V is maintained until the cell reached its rated capacity. Discharge density was maintained at C/10 for the first 2 charge cycles, and cutoff voltage was 1.1 V. For subsequent charge cycles, charge current was increased to C/7.5 until voltage reached 2.03 V, then a constant voltage at 1.98V is kept for charging until the cell reached to the rated capacity, and discharge density is kept at C/5, and the cutoff voltage is 1.1V. Note that C is the rated capacity of the cell based on the amounts of electrode and cathode materials.

The cell profiled in FIGS. 2A and 2B was designed to have a 1 Ah capacity and was continuously charged and discharged for a period of more than 35 hours. The charge current was C/10 for the first 2 charge cycles and reached 2.03 V. After the first 2 charge cycles, the cell is charged to maintain a constant voltage of 1.98V until the cell reached its rated capacity. For the first 2 charge cycles, discharge density was C/10 and cutoff voltage was 1.1 V. For subsequent charge cycles, charge current was increased to C/7.5 until voltage reached 2.03 V, then a constant voltage of 1.98V was maintained until the cell reached its rated capacity. Discharge density was C/5, and the cutoff voltage was 1.1V. Throughout the charge cycles illustrated, the capacity, voltage, and current remain substantially unchanged for each charge cycle for at least 5 charge cycles over a period of more than 35 hours. FIG. 2B shows the charge profile of the cell over an extended time, i.e., over 420 hours, and demonstrates that the capacity, voltage, and current remain substantially unchanged for at least 32 charge cycles over the period of over 420 hours. This demonstrates the usefulness of a Zn anode having 5 wt % PVDF as a binder in electrochemical cells.

Furthermore, the over potential of this cell is very low, which indicates that the impedance of this cell is also very low. The upper voltage during charge is ˜1.9V at C/10 current rate, which is much lower than the standard value of ˜1.94V. This behavior may relate to the excellent binding strength of the PVDF that would reduce the interface impedance between the active material and the current collector resulting a low overall cell impedance.

### Example 4

### Test Cell 2 for the Evaluation of PVDF Binder

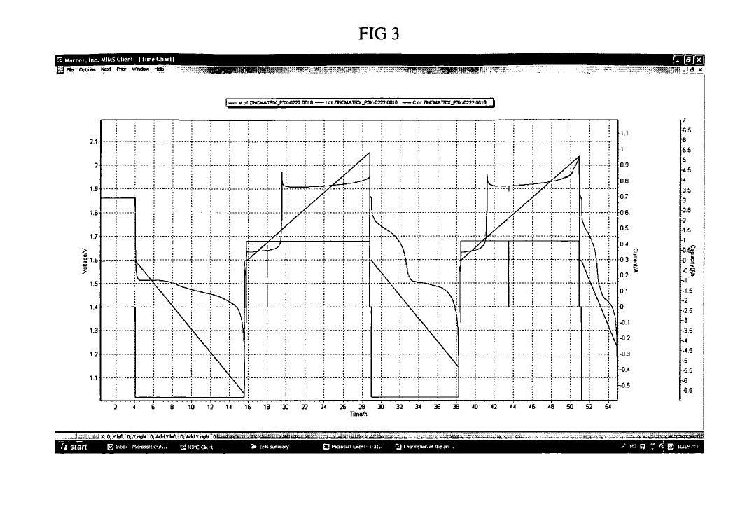

FIGS. 1 and 3 illustrate cell configuration and a charge profile for another exemplary electrochemical cell of the present invention. FIG. 3 shows a trace of: 1. cell voltage vs. time; 2. cell capacity vs. time; and 3. charge current vs. time, wherein each of the traces is superimposed on the same graph.

This cell was produced using the following materials:

Cathode: Test Cathode Active Material with 1 wt % PTFE binder

Anode: Zn with 3 wt % PVDF binder

Electrolyte: (32 wt % conc.) aq. KOH

The electrodes were separately wrapped in a PEO film formulated as described in Example 3. A separator was situated between the electrodes, which was formulated as described in Example 3. The separator was soaked in the KOH solution for 12 hours before being assembled into the cell. Charge current was C/10 for the first 2 charge cycles and reached 2.03 V. After the first 2 charge cycles, a constant voltage of 1.98V is maintained until the cell reached its rated capacity. Discharge density was maintained at C/10 for the first 2 charge cycles, and cutoff voltage was 1.1 V. For subsequent charge cycles, charge current was increased to C/7.5 until voltage reached 2.03 V, then a constant voltage at 1.98V is kept for charging until the cell reached to the rated capacity, and discharge density is kept at C/5, and the cutoff voltage is 1.1V.

Referring to FIG. 3, cell 2 was designed to have a 1 Ah capacity and was continuously charged and discharged according to the procedure described in Example 3, above. Throughout the charge cycles illustrated, the capacity, voltage, and current remain substantially unchanged for each charge cycle for at least 2 charge cycles over a period of more than 50 hours. This demonstrates the usefulness of a Zn anode having 3 wt % PVDF as a binder in electrochemical cells.

### Example 5

### Test Cells 3-5 for the Evaluation of PVDF Binder

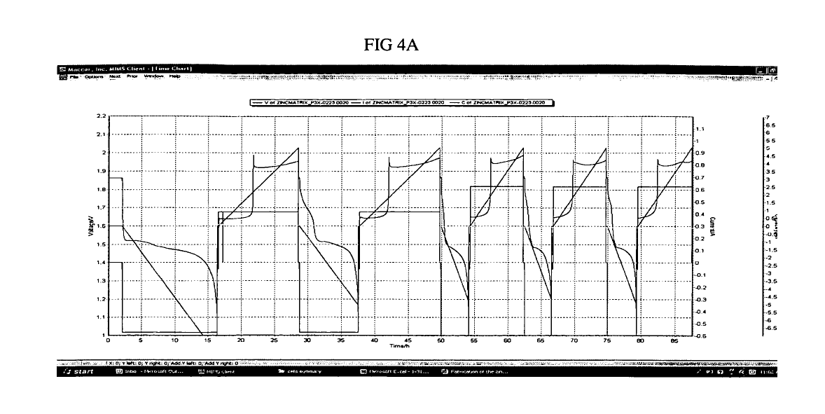

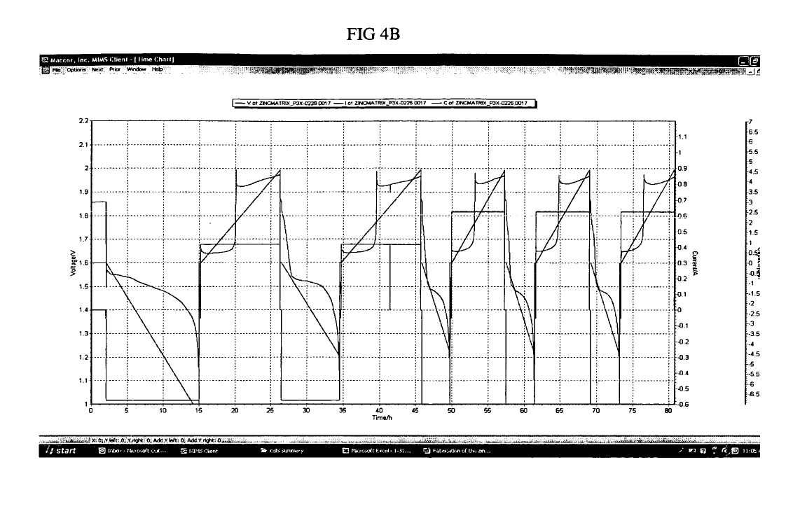

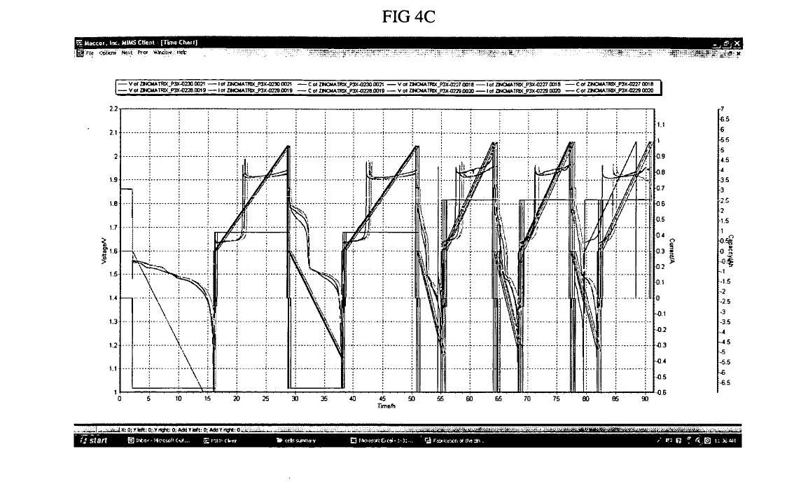

FIGS. 1 and 4A-4C illustrate a cell configuration and charge profiles for three exemplary electrochemical cells of the present invention. These figures show traces of: 1. cell voltage vs. time; 2. cell capacity vs. time; and 3. charge current vs. time, wherein each of the traces is superimposed on the same graph in each of the figures.

These cells were produced using the following materials:

Cathode: Test Cathode Active Material 1 wt % PTFE binder

Anode: Zn with 2 wt % PVDF binder

Electrolyte: (32 wt % conc.) aq. KOH

In cell nos. 3 and 4, profiled in FIGS. 4A and 4B, the electrodes were wrapped in a PEO film formulated as described in Examples 3 and 4. A separator, as described in Example 3, was placed between the electrodes. The separator was soaked in the KOH solution for 12 hours before being assembled into the cell. The cells were charged and discharged as described in Examples 3 and 4 above.

In cell no. 5, profiled in FIG. 4C, the electrodes were wrapped in a commercially available separator material, Solupor, and the separator was formulated to include 2 PVA films that were layered on opposing sides of a Solupor substrate to produce a separator having the following layered order by thickness: PVA-Solupor-PVA. Each of the PVA films was produced as described in Example 3, and cast sequentially onto the Solupor substrate. However, it is noted that each of the PVA films could be coextruded along with the Solupor substrate to form this type of separator.

The cell was charged and discharged as described in Examples 3 and 4, above.

The charge profiles illustrated in FIGS. 4A-4C show charge and discharge features that remain substantially unchanged for 5 charge cycles over a period of about 80 to 90 hours.

### Example 6

### Test Cells 6-8 for the Evaluation of PVDF Binder

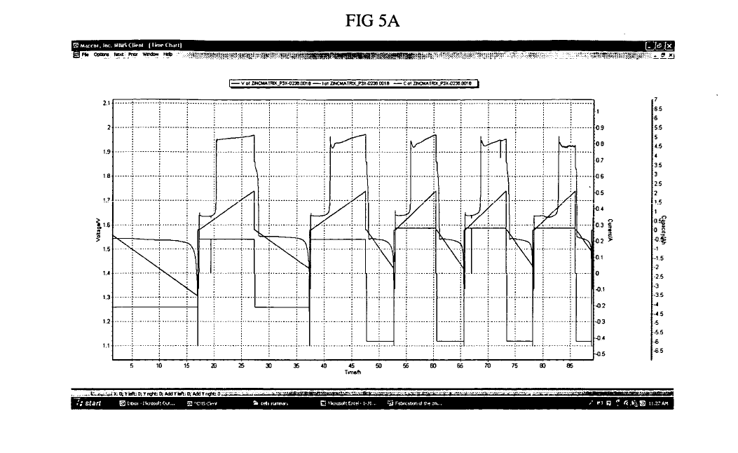

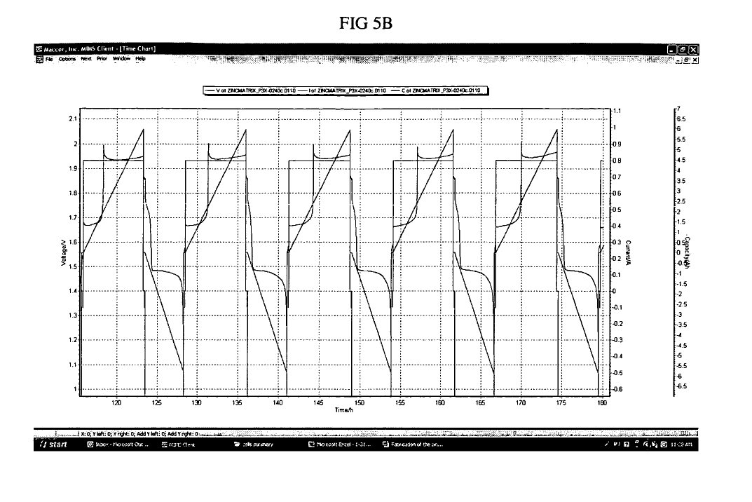

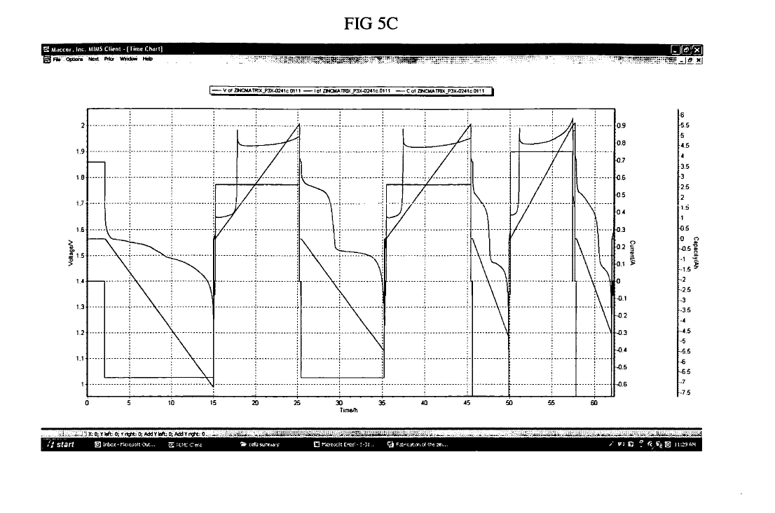

FIGS. 5A-5C illustrate charge profiles for three exemplary electrochemical cells configured as illustrated in FIG. 1. These figures show traces of: 1. cell voltage vs. time; 2. cell capacity vs. time; and 3. charge current vs. time, wherein each of the traces is superimposed on the same graph in each of the figures.

These cells were produced using the following materials:

Cathode: Test Cathode Active Material with 5 wt % PVDF binder

Anode: Zn with 2 wt % PVDF-co-HFP binder

Electrolyte: (32 wt % conc.) aq. KOH

In cell 6, profiled in FIG. 5A, the electrodes were separately wrapped in Solupor. A separator, as described in Example 5 above, was situated between the electrodes. The separator was soaked in the KOH solution for 12 hours before being assembled into the cell. The cell was charged and discharged as described in Examples 3 and 4 above.

In cells 7 and 8, profiled in FIGS. 5B and 5C, the electrodes were separately wrapped in Solupor, and the separator was formed from two layers of PVA-film that were produced as described above in Example 3. As in Example 5, it is noted that the PVA films can be coextruded to form the double layered separator.

The cells were charged and discharged as described in Example 3 above.

The charge profiles illustrated in FIGS. 5A-5C show charge and discharge features that remain substantially unchanged for up to 8 charge cycles over a period of about 120 hours.

It is noted that cells with different rated capacities (1.0 Ah, 5.6 Ah, 6.0 Ah), the rated charge capacity was obtained in one single CC step indicating excellent initial cell performance.

### Example 7

### Test Cell 9 for the Evaluation of PVDF Binder

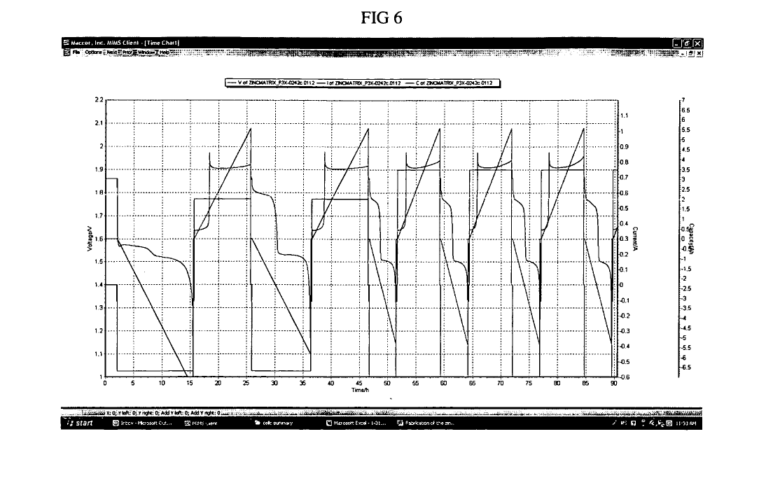

FIG. 6 illustrates the charge profile of test cell no. 9, which is configured as illustrated in FIG. 1 and had a 5.6 Ah rated capacity. FIG. 6 shows traces of: 1. cell voltage vs. time; 2. cell capacity vs. time; and 3. charge current vs. time, wherein each of the traces is superimposed on the same graph.

This cell was produced using the following materials:

Cathode: Test Cathode Active Material with 3 wt % PVDF binder

Anode: Zn with 2 wt % PVDF-co-HFP binder

Electrolyte: (32 wt % conc.) aq. KOH

In cell 9, the electrodes were separately wrapped in Solupor. The separator, as described in Example 3, was soaked in the KOH solution for 12 hours before being assembled into the cell. This cell was designed to have a rated capacity of about 5.6 Ah. The cells were charged and discharged as described in Examples 3 and 4 above.

### Example 8

### Test Cell 10 for the Evaluation of PVDF Binder

Cell 10 was produced using the following materials:

Cathode: Test Cathode Active Material with 5% PVDF-co-HFP;

Anode: Zn with 2% PVDF-co-HFP

Electrolyte: (32 wt % conc.) aq. KOH

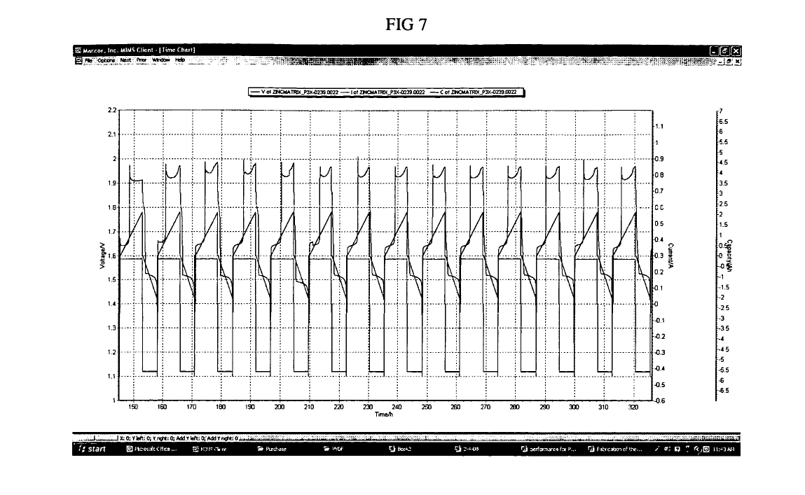

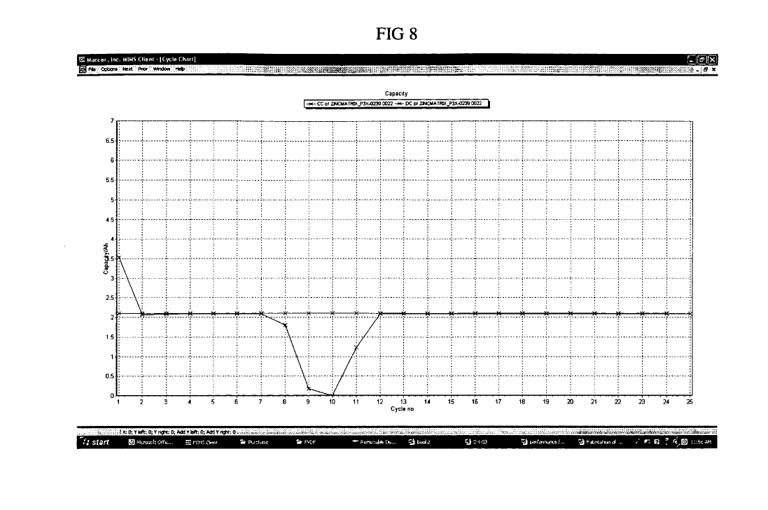

In cell 10, the electrodes were separately wrapped in Solupor. The separator, as used in cell no. 6 of Example 5, was soaked in the KOH solution for 12 hours before being assembled into the cell. The cell was charged and discharged as described in Example 3. Cell 10's charge profile is illustrated in FIG. 7. FIG. 8 is a trace of cell capacity as a function of charge cycles. It is noted that the charge capacity of cell 10 does not substantially change in over about 24 charge cycles.

### Example 9

### Test Cell 11 for the Evaluation of PVDF Binder

Cell 11 was produced using the following materials:

Cathode: Test Cathode Active Material with 3% PVDF-co-HFP;

Anode: Zn-10 (90.56%), ZnO (6.97%), Bi₂O₃ (0.47%) with 2% PVDF-co-HFP;

Electrolyte: (32 wt % conc.) aq. KOH

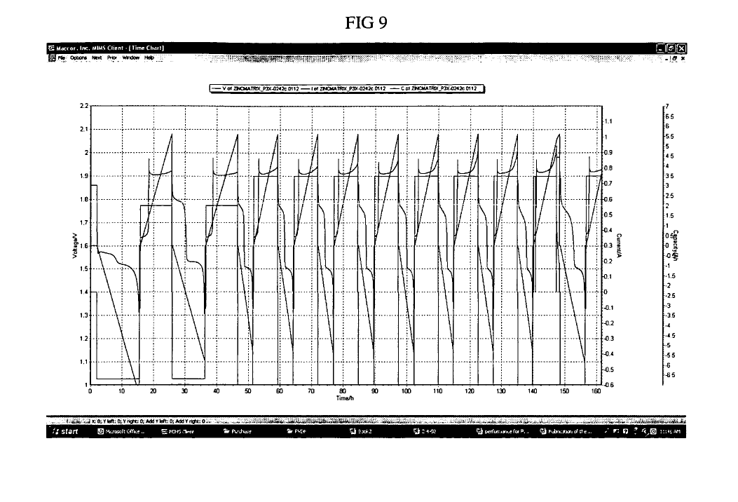

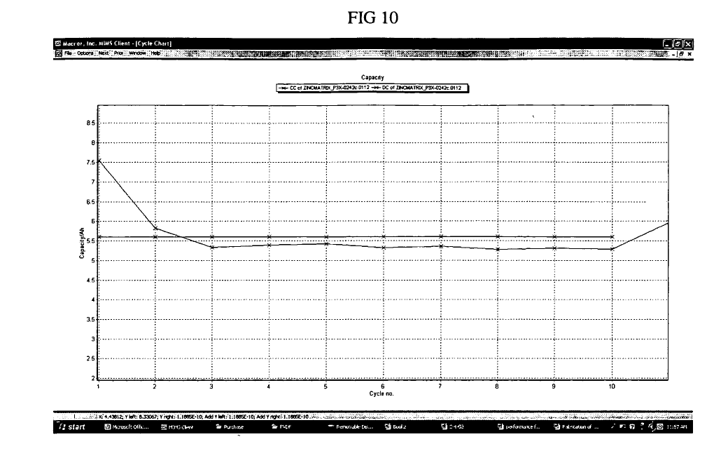

In cell 11, the electrodes were separately wrapped in Solupor. The separator, as described in Example 3, was soaked in the KOH solution for 12 hours before being assembled into the cell. The cell was charged and discharged as described in Example 3. Cell 11's charge profile is illustrated in FIG. 9. FIG. 10 is a trace of cell capacity as a function of charge cycles. It is noted that the charge capacity of cell 11 does not substantially change in over about 10 charge cycles.

### Example 10

### Test Cell 12 for the Evaluation of PVDF Binder

Cell 12 was produced using the following materials:

Cathode: Test Cathode Active Material with 2% PVDF-co-HFP

Anode: Zn-10 (90.56%), ZnO (6.97%), Bi₂O₃ (0.47%) with 2% PVDF-co-HFP

Electrolyte: (32 wt % conc.) aq. KOH

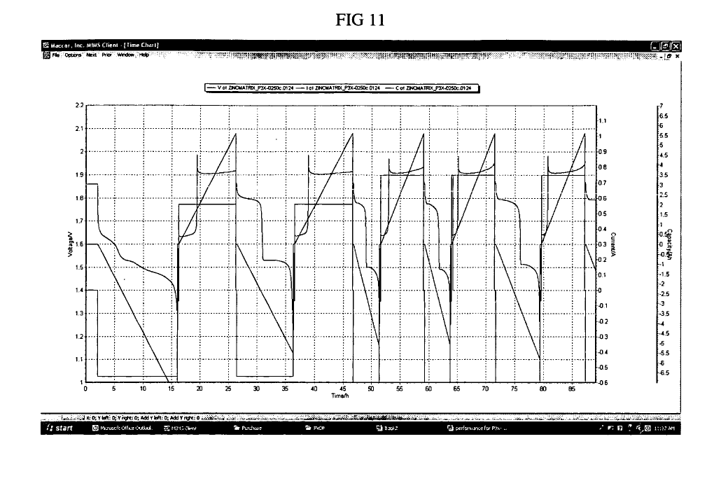

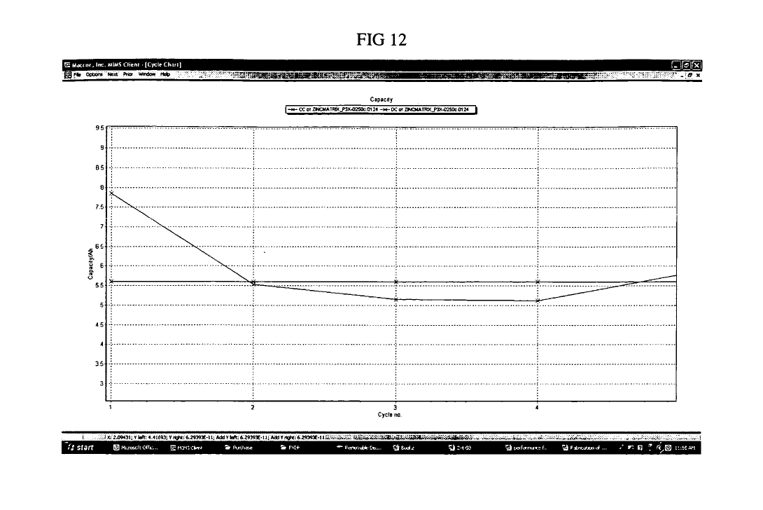

In cell 12, the electrodes were separately wrapped in Solupor. The separator, as described in Example 3, was soaked in the KOH solution for 12 hours before being assembled into the cell. The cell was charged and discharged as described in Example 3. Cell 12's charge profile is illustrated in FIG. 11. FIG. 12 is a trace of cell capacity as a function of charge cycles.

### Example 11

### Test Cell 13 for the Evaluation of PVDF Binder

Cell 13 was produced using the following materials:

Cathode: Test Cathode Active Material with 1% PVDF-co-HFP

Anode: Zn-10 (90.56%), ZnO (6.97%), Bi₂O₃ (0.47%) with 2% PVDF-co-HFP

Electrolyte: (32 wt % conc.) aq. KOH

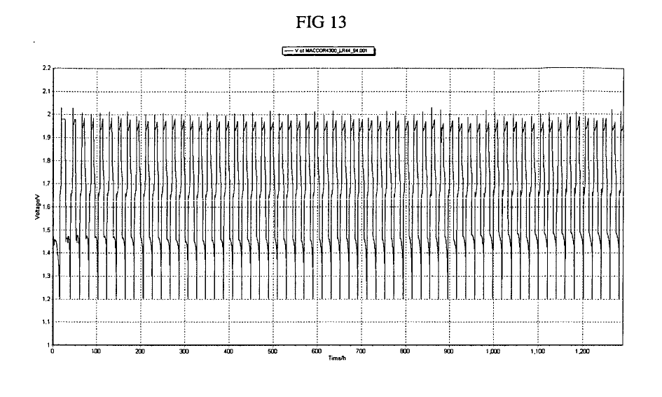

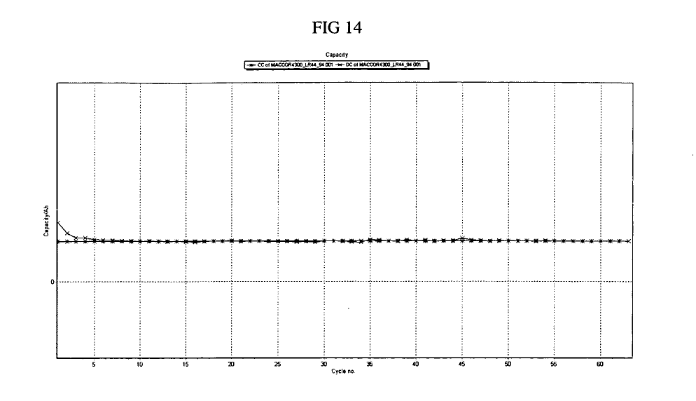

In cell 13, the electrodes were separately wrapped in Solupor. The separator included 4 layers ordered by thickness as Solupor-PVA-PVA-Solupor. To form this separator, PVA film was cast on a Solupor substrate as described in Examples 3 and 4. The resulting PVA film was layered onto another PVA film having a Solupor substrate to form the present separator. This separator was soaked in the KOH solution for 12 hours before being assembled into the cell. The cell was charged and discharged as described in Example 3. Cell 13's charge profile is illustrated in FIG. 13. FIG. 14 is a trace of cell capacity as a function of charge cycles.

### Example 12

### Test Cell 14 for the Evaluation of PVDF Binder

Cell 14 was produced using the following materials:

Cathode: Test Cathode Active Material with 1 wt % PTFE binder

Anode: Zn with 2 wt % PVDF-co-HFP binder

Electrolyte: (32 wt % conc.) aq. KOH

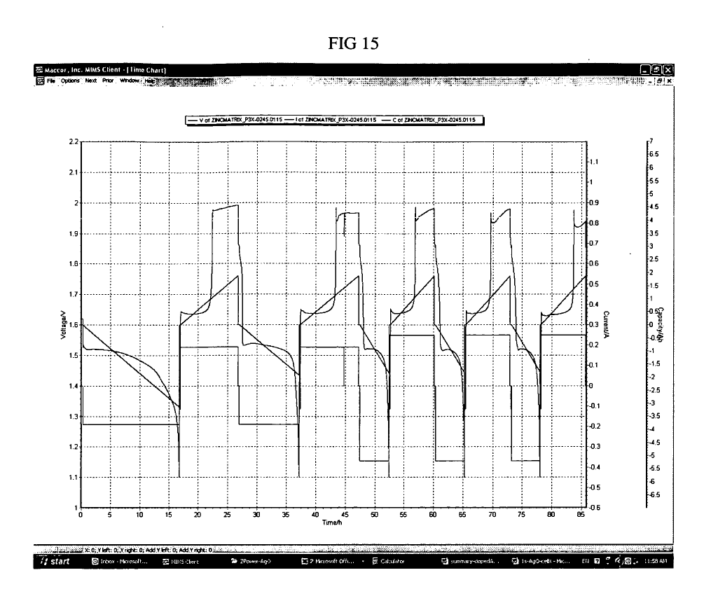

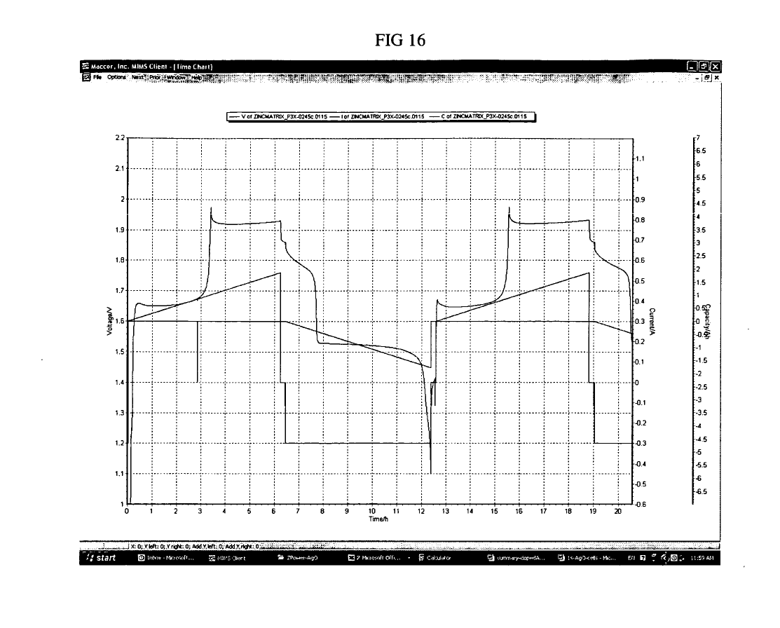

In cell 14, the electrodes were separately wrapped in Solupor. The separator, as described in Example 3, was soaked in the KOH solution for 12 hours before being assembled into the cell. The cell was charged and discharged as described in Example 3. Cell 14's charge profile is illustrated in FIGS. 15 and 16. FIG. 16 is the charge profile of cell 14, after the cell has been rebagged.

### Example 13

### Test Cell 15 for the Evaluation of PVDF Binder

Cell 15 was produced to have a rated capacity of 1.9 Ah using the following materials:

Cathode material: Test Cathode Active Material with 1% PTFE as binder

Anode material: Zn and 2 wt % PVDF as binder

Electrolyte: (32 wt % conc.) aq. KOH

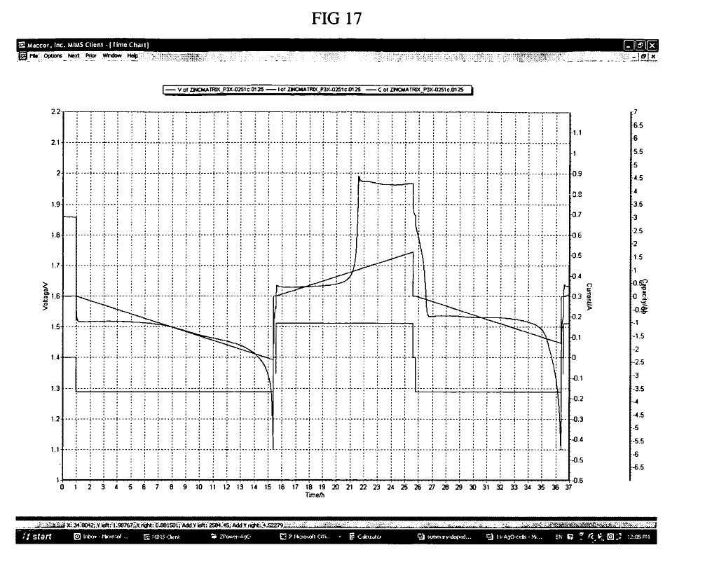

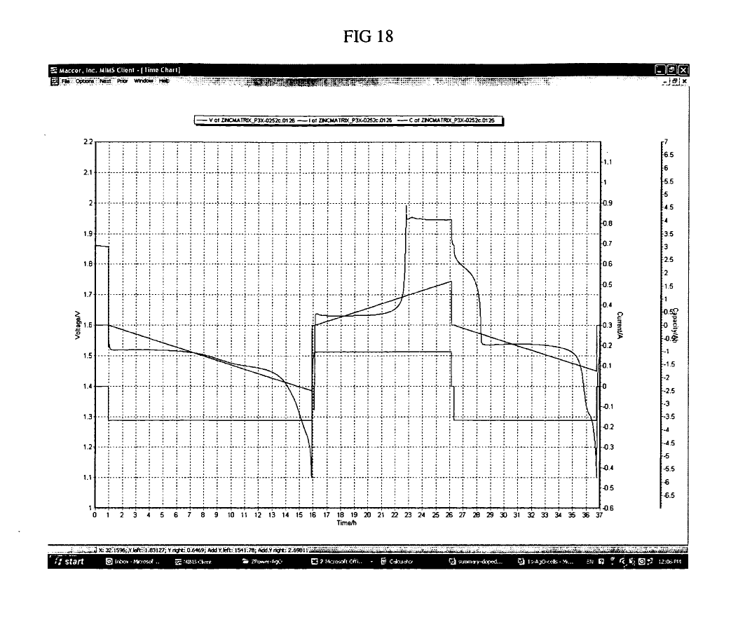

In cell 15, the cathode was wrapped in Scimat film and the anode was wrapped in Solupor. The separator was formed to include 3 layers including 1 PEO-layer and 2 PVA layers. The PVA layers and the PEO layers were produced as described in Example 3. By thickness, the order of these layers was PEO-PVA-PVA. This separator was soaked in the KOH solution for 12 hours before being assembled into the cell. The cells was charged and discharged as described in Example 3. Cell 15's charge profile is illustrated in FIGS. 17 and 18.

### Other Embodiments

All publications and patents referred to in this disclosure are incorporated herein by reference to the same extent as if each individual publication or patent application were specifically and individually indicated to be incorporated by reference. Should the meaning of the terms in any of the patents or publications incorporated by reference conflict with the meaning of the terms used in this disclosure, the meaning of the terms in this disclosure are intended to be controlling. Furthermore, the foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

1. An electrode for use in an alkaline battery comprising:
a binder material, and
an active material,
wherein the binder material comprises PVDF or a PVDF copolymer.

2. The electrode of claim 1, wherein the active material comprises at least one metal oxide.

3. The electrode of claim 1, wherein the active material comprises at least one metal.

4. The electrode of claim 1, wherein the active material comprises AgO, Ag₂O₃, Zn, or ZnO.

5. The electrode of claim 4, wherein the binder material comprises a PVDF copolymer.

6. The electrode of claim 5, wherein the PVDF copolymer consists essentially of PVDF-co-HFP.

7. The electrode of claim 6, further comprising from about 1.5 wt % to about 10 wt % of binder material.

8. The electrode of claim 7, further comprising from about 1.5 wt % to about 7 wt % of binder material.

9. The electrode of claim 8, further comprising Bi₂O₃.

10. The electrode of claim 9, further comprising from about 0.3 wt % to about 0.6 wt % of Bi₂O₃.

11. An electrochemical cell comprising:
an alkaline electrolyte;
a cathode; and
an anode;
wherein the cathode comprises a first active material and a first binder material; the anode comprises a second active material and a second binder material; and the first binder material, the second binder material, or both comprises PVDF or a PVDF copolymer.

12. The electrochemical cell of claim 11, wherein the cathode comprises up to at least 90 wt % of the first active material.

13. The electrochemical cell of claim 12, wherein the first active material is selected from AgO, Ag₂O, Ag₂O₃, HgO, Hg₂O, CuO, CdO, NiOOH, Pb₂O₄, PbO₂, LiFePO₄, Li₃V₂(PO₄)₃, V₆O₁₃, V₂O₅, Fe₃O₄, Fe₂O₃, MnO₂, LiCoO₂, LiNiO₂, LiMn₂O₄, or any combination thereof.

14. The electrochemical cell of claim 13, wherein the first active material is AgO or Ag₂O₃.

15. The electrochemical cell of claim 14, wherein the cathode comprises up to 10 wt % of a first binder material.

16. The electrochemical cell of claim 15, wherein the cathode comprises up to 6 wt % of a first binder material.

17. The electrochemical cell of claim 16, wherein the first binder material comprises PVDF or PVDF copolymer.

18. The electrochemical cell of claim 17, wherein the first binder material comprises a PVDF copolymer.

19. The electrochemical cell of claim 18, wherein the PVDF copolymer is PVDF-co-HFP copolymer.

20. The electrochemical cell of claim 19, wherein the PVDF-co-HFP copolymer has a mean molecular weight of less than about 600,000 amu.

21. The electrochemical cell of claim 20, wherein the PVDF-co-HFP copolymer has a mean molecular weight of less than about 500,000 amu.

22. The electrochemical cell of claim 11, wherein the anode comprises up to 90 wt % of the second active material.

23. The electrochemical cell of claim 22, wherein the second active material is selected from Si, Sn, Al, Ti, Mg, Fe, Bi, Zn, Sb, Ni, Pb, Li, Zr, Hg, Cd, Cu, LiC6, mischmetals, alloys thereof, oxides thereof, or composites thereof.

24. The electrochemical cell of claim 23, wherein the anode comprises a second active material selected from Zn or ZnO.

25. The electrochemical cell of claim 24, wherein the anode comprises up to 10 wt % of a second binder material.

26. The electrochemical cell of claim 25, wherein the anode comprises up to 6 wt % of a second binder material.

27. The electrochemical cell of claim 26, wherein the second binder material comprises PVDF or PVDF copolymer.

28. The electrochemical cell of claim 27, wherein the second binder material comprises a PVDF copolymer.

29. The electrochemical cell of claim 28, wherein the PVDF copolymer is PVDF-co-HFP copolymer.

30. The electrochemical cell of claim 29, wherein the PVDF-co-HFP copolymer has a mean molecular weight of less than about 600,000 amu.

31. The electrochemical cell of claim 30, wherein the PVDF-co-HFP copolymer has a mean molecular weight of less than about 500,000 amu.

32. The electrochemical cell of claim 11, wherein the alkaline electrolyte comprises LiOH, NaOH, KOH, CsOH, RbOH, or any combination thereof.

33. The electrochemical cell of claim 32, wherein the alkaline electrolyte has a concentration of NaOH or KOH of at least 4 M.

34. The electrochemical cell of claim 33, wherein the alkaline electrolyte comprises KOH.

35. A method of manufacturing an electrochemical cell comprising
providing a cathode comprising AgO and a first binder material;
providing an anode comprising Zn or ZnO and a second binder material; and
providing an alkaline electrolyte;
wherein the alkaline electrolyte comprises NaOH or KOH in a concentration of at least 8 M, the cathode comprises at least about 88 wt % of AgO, the anode comprises at least 88 wt % of Zn or ZnO, and either the first binder material, the second binder material, or both comprises PVDF or PVDF copolymer.
